(19) United States
(12) Patent Application Publication
(10) Pub. No.: US 2026/0042199 A1
(43) Pub. Date: Feb. 12, 2026

(54) ELECTRIC POWER TOOL

(71) Applicant: MAKITA CORPORATION, Anjo-shi (JP)

(72) Inventor: Hiroka SUZUKI, Anjo-shi (JP)

(73) Assignee: MAKITA CORPORATION, Anjo-shi (JP)

(21) Appl. No.: 19/279,368

(22) Filed: Jul. 24, 2025

(30) Foreign Application Priority Data
Aug. 9, 2024 (JP) 2024-134500

(51) Int. Cl. B25F 5/02; H01M 50/543

(52) U.S. Cl. CPC B25F 5/02; H01M 50/543

(57) ABSTRACT

An electric power tool includes a motor, an output unit driven by the motor, a metallic housing, a cover, an electrical part, and a battery mounting portion. The metallic housing houses the output unit and extends forward. The cover is made of resin that covers at least a part of the housing. The electrical part is disposed on a front portion side of the housing. The battery mounting portion has positive and negative terminals to which a mounted battery is electrically connected. On an outer surface between front and rear faces of the housing, a connecting portion of a ground wire connected to the negative terminal of the battery mounting portion is disposed in a conductive state with the outer surface. A partitioning portion is formed in the cover and partitions between a lead wire for electrical component connected to the electrical part and the connecting portion.

### CROSS REFERENCE TO RELATED APPLICATION

This application claims the benefit of Japanese Patent Application Number 2024-134500 filed on Aug. 9, 2024, the entirety of which is incorporated by reference.

### FIELD OF THE INVENTION

The disclosure relates to an electric power tool. The electric power tool is, for example, an impact tool that has a hammering unit as an output unit and causes an anvil to generate intermittent impact, namely a rotational hammering force.

### BACKGROUND OF THE INVENTION

A known electric power tool includes a light that illuminates the front of an output unit to make a work area easier to view.

For example, JP 2024-79576 A discloses an impact tool that includes a light that illuminates the front of an anvil projecting forward at the front end of a hammer case that houses a hammering unit as an output unit.

Incidentally, a rechargeable electric power tool using a battery as a power source possibly causes a controller to malfunction due to electrical noise emitted by high-voltage power transmission lines when used in the vicinity of the power transmission lines. To avoid the malfunction, measures are taken to electrically conduct a negative terminal of the battery to a metallic housing, such as a hammer case, via a grounding lead wire (hereinafter referred to as a “ground wire”).

However, when the ground wire is installed on the rear face of the housing, it is necessary to secure space, for example, for fastening a terminal metal fitting disposed to the ground wire with screws from the rear. As a result, the overall length in a front-rear direction becomes longer, hindering downsizing.

Therefore, it is conceivable that the ground wire is connected to the lower surface or side surface of the housing using a screw or, for example, a terminal insertion structure, such as a receptacle. Thus, a connecting portion fits between the front and rear faces of the housing, eliminating the need to ensure space at the rear.

However, in a case where an electrical part, such as a light, is disposed at the front portion of the output unit as in JP 2024-79576 A, when a lead wire for electrical component connected to the electrical part is wired along the outer surface of the housing, screws with which the terminal metal fitting is installed and terminals may come into contact with the lead wire for electrical component. The ground wire may also come into contact with the lead wire for electrical component. In this case, vibration generated during the use of the tool possibly causes wear to the wires, or it causes the screws to fall off when the connecting portion is fastened with screws.

It is an object of the disclosure to provide an electric power tool that does not hinder downsizing even when a ground wire and a lead wire for electrical component are wired, and can effectively avoid the occurrence of defects associated with vibration, such as wear of wire.

### SUMMARY OF THE INVENTION

In order to solve the above-described issue, the present disclosure provides an electric power tool that includes a motor, an output unit driven by the motor, a metallic housing, a cover, an electrical part, and a battery mounting portion. The metallic housing houses the output unit and extends forward. The cover is made of resin that covers at least a part of the housing. The electrical part is disposed on a front portion side of the housing. A battery as a power source is mountable to the battery mounting portion. The battery mounting portion has positive and negative terminals to which the mounted battery is electrically connected. On an outer surface between front and rear faces of the housing, a connecting portion of a ground wire connected to the negative terminal of the battery mounting portion is disposed in a conductive state with the outer surface. A partitioning portion is formed in the cover. The partitioning portion partitions between a lead wire for electrical component connected to the electrical part and the connecting portion.

In the disclosure, the “front portion side of the housing” on which the electrical part is disposed includes both a case where the electrical part is disposed directly at the front portion of the housing and a case where the electrical part is disposed not directly in the housing but in the vicinity of the front portion of the housing.

The disclosure allows the ground wire to be connected between the front and rear faces of the housing, and it eliminates contact of a screw with which the ground wire is installed and terminals with the lead wire for electrical component or contact of the ground wire with the lead wire for electrical component. Accordingly, even when the ground wire and the lead wire for electrical component are wired, downsizing is not hindered, and the occurrence of defects associated with vibration, such as wear of wire, can be effectively avoided.

### BRIEF DESCRIPTION OF THE DRAWINGS

FIG. 1 is a perspective view from the front of a rechargeable impact wrench.

FIG. 2 is a center vertical cross-sectional view of the rechargeable impact wrench.

FIG. 3 is an exploded perspective view of the front portion of the rechargeable impact wrench including a part of a main body housing when viewed from the front.

FIG. 4 is an enlarged cross-sectional view taken along the line A-A in FIG. 2.

FIG. 5 is an exploded perspective view of the front portion of the rechargeable impact wrench when viewed from the rear.

FIG. 6 is an enlarged cross-sectional view taken along the line B-B in FIG. 2.

FIG. 7 is an enlarged cross-sectional view taken along the line C-C in FIG. 2.

### DETAILED DESCRIPTION OF THE INVENTION

In one embodiment of the present disclosure, the electric power tool may include a main body including the motor and the output unit and extending in a front-rear direction and a handle extending downward from the main body. The battery mounting portion may be disposed at a lower end of the handle. The connecting portion may be disposed on a lower surface of the housing. The partitioning portion is disposed on a lower surface of the cover.

With the configuration, the ground wire can be connected to the housing on the lower side of the main body, where the ground wire comes close to a negative terminal of a battery mounting portion.

In one embodiment of the present disclosure, the partitioning portion may have a bent portion that is bent to a side of the lead wire for electrical component, and the cover, the partitioning portion, and the bent portion form a wiring route of the lead wire for electrical component.

The configuration eliminates the possibility of the lead wire for electrical component being trapped in, for example, a mating face of the housing during assembly and repair.

In one embodiment of the present disclosure, an outer housing that partially covers the cover may be disposed on a lower side of the cover, and the connecting portion and the partitioning portion may be arranged between the cover and the outer housing.

With the configuration, the outer housing can be used to connect the ground wire and to wire the lead wire for electrical component, and the ground wire and the lead wire for electrical component are protected.

In one embodiment of the present disclosure, the partitioning portion may be integrally formed with the cover.

With the configuration, the partitioning portion can be easily formed.

In one embodiment of the present disclosure, the connecting portion may be a screw fastening portion, and the partitioning portion may be positioned in a withdrawal direction of a screw with which the ground wire is installed to the screw fastening portion and is close to or in contact with a head of the screw.

With the configuration, the partitioning portion can effectively avoid detachment of the screw.

In one embodiment of the present disclosure, the electrical part may be a light for illumination.

With the configuration, wear and damage to the lead wire for electrical component can be effectively avoided even when the light is disposed on the front portion side of the housing.

In one embodiment of the present disclosure, the output unit may be a hammering unit that applies intermittent hammering in a direction of rotation to an anvil projecting forward, the housing may be a hammer case that supports the anvil, and the cover may be a hammer case cover that covers an outside of the hammer case.

The configuration can effectively avoid detachment of the screw and wear of the ground wire and the lead wire for electrical component in an impact tool that generates relatively large vibration during its use.

In one embodiment of the present disclosure, the connecting portion may be a screw fastening portion, the screw fastening portion may be formed on a lower surface of the housing and projects downward through the cover, the partitioning portion may extend in a front-rear direction on a lower surface of the cover and partitions between the screw fastening portion and the lead wire for electrical component, and the partitioning portion may be positioned in a withdrawal direction of a screw with which the ground wire is installed to the screw fastening portion and is close to or in contact with a head of the screw. A bent portion that is bent to a side of the lead wire for electrical component may be formed at a lower end of the partitioning portion, and a wiring route of the lead wire for electrical component may be linearly formed by the cover, the partitioning portion, and the bent portion in a state of overlapping with the screw fastening portion and the ground wire in a left-right direction.

With the configuration, the screw fastening portion and the ground wire can be arranged in a space-saving manner.

The following describes an embodiment of the disclosure based on the drawings.

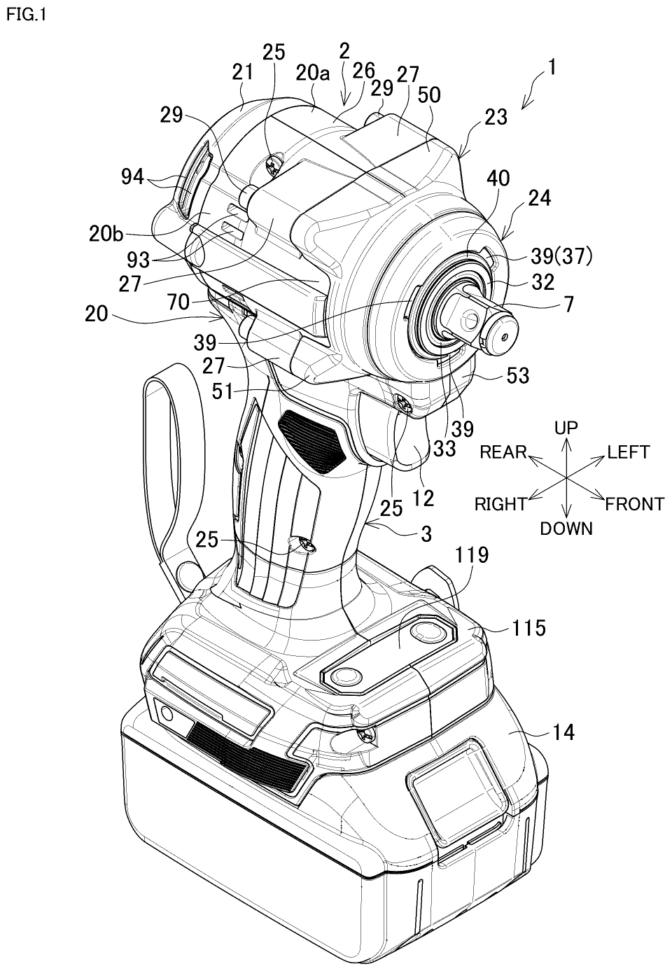

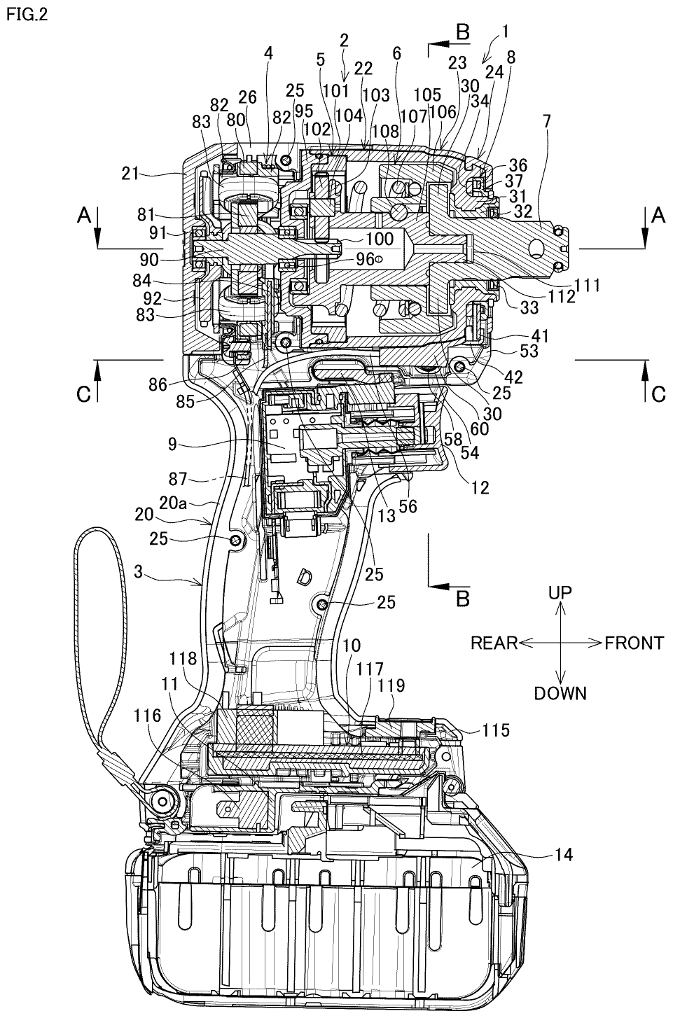

FIG. 1 is a perspective view from the front of a rechargeable impact wrench, which is an example of the electric power tool, and FIG. 2 is a center vertical cross-sectional view of the rechargeable impact wrench.

A rechargeable impact wrench (hereafter simply referred to as an “impact wrench”) 1 includes a main body 2 and a handle 3. The main body 2 extends in a front-rear direction, and the handle 3 extends downward from the main body 2. The main body 2 houses a motor 4, a deceleration unit 5, a hammering unit 6, and an anvil 7 from the rear. The anvil 7 has a front end to which a socket (not illustrated) that projects forward from the main body 2 is mountable. The hammering unit 6 is an example of the output unit of the disclosure.

A light unit 8 that illuminates the front of the anvil 7 is disposed on the front face of the main body 2. The light unit 8 is an example of the light as an electrical part of the disclosure.

The handle 3 houses a switch 9, a controller 10, and a terminal block 11. A trigger 12 that projects forward on the lower side of the main body 2 is disposed in the switch 9. A forward and reverse switching button 13 that switches the direction of rotation of the anvil 7 is disposed on the upper side of the switch 9. A battery pack 14 as a power source is attachably and detachably mounted at the lower end of the handle 3. The battery pack 14 is an example of a battery of the disclosure.

The impact wrench 1 has an outer wall formed of a main body housing 20, a rear cover 21, a hammer case 22, a hammer case cover 23, and a bumper 24.

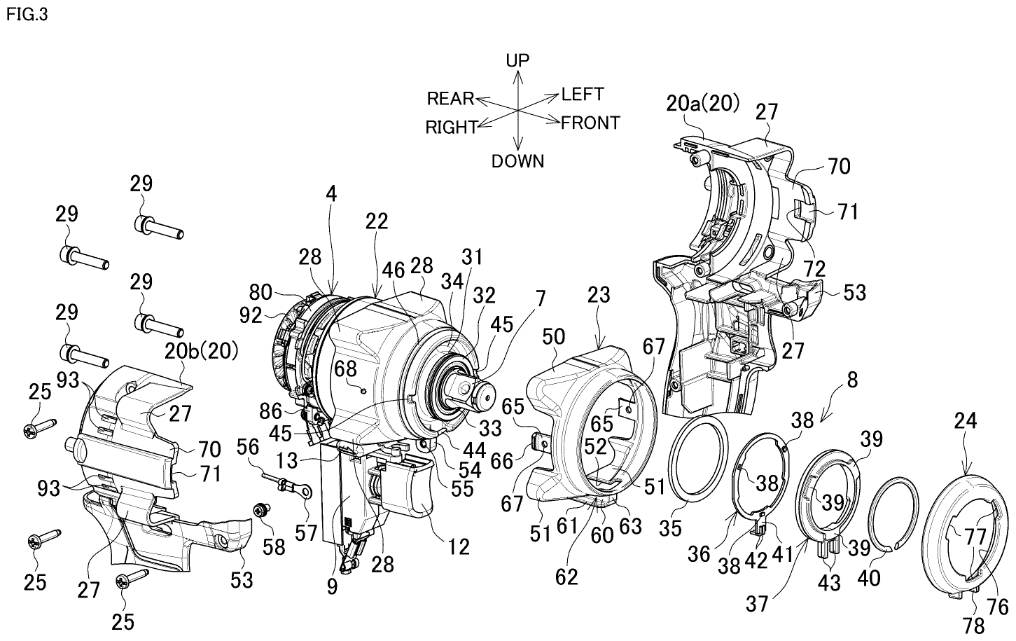

First, the main body housing 20 is made of resin and is formed from the middle portion in the front-rear direction of the main body 2 to the handle 3. As illustrated also in FIG. 3, the main body housing 20 is formed by fastening a pair of right and left halved housings 20a, 20b with a plurality of screws 25 from the right side.

The rear cover 21 is made of resin and has a cap shape that covers the rear portion of the main body 2. The rear cover 21 is fastened with screws to a tubular portion 26 formed at the upper portion of the main body housing 20 at two right and left positions from the rear. The motor 4 is housed inside the rear cover 21 and the tubular portion 26.

The hammer case 22, which is a metallic tubular body, is fastened with screws to the tubular portion 26 with its rear portion held by the tubular portion 26 and covers the front portion of the main body 2. The hammer case 22 is an example of a metallic housing of the disclosure.

The tubular portion 26 has upper, lower, left, and right four corners at which screw receiving portions 27 project in a front view. The hammer case 22 also has upper, lower, left, and right four corners where screw boss portions 28 that project are disposed. The hammer case 22 is fastened by four bolts 29 which are threaded through the screw receiving portions 27 from the rear and are screwed into the screw boss portions 28.

The deceleration unit 5, the hammering unit 6, and the rear portion of the anvil 7 are housed inside the hammer case 22. At the rear portion of the anvil 7, a pair of arm portions 30 projecting outward in a radial direction are disposed. The anvil 7 projects forward through a front cylinder portion 31 with a small diameter formed at the front portion of the hammer case 22. An insert sleeve 32 that rotatably supports the anvil 7 is held inside the front cylinder portion 31. An oil seal 33 is held at the front portion of the insert sleeve 32.

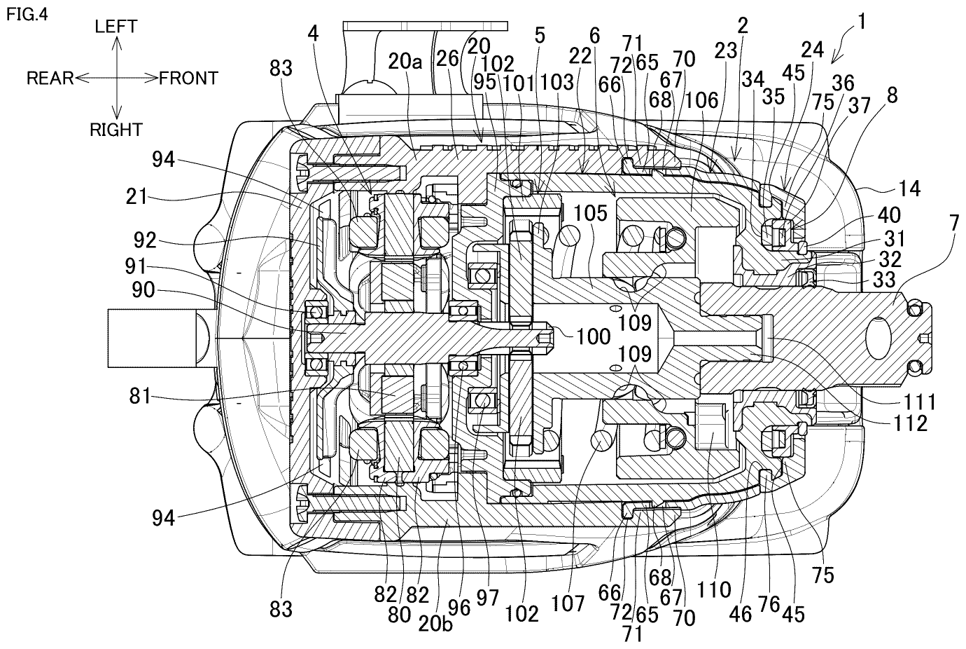

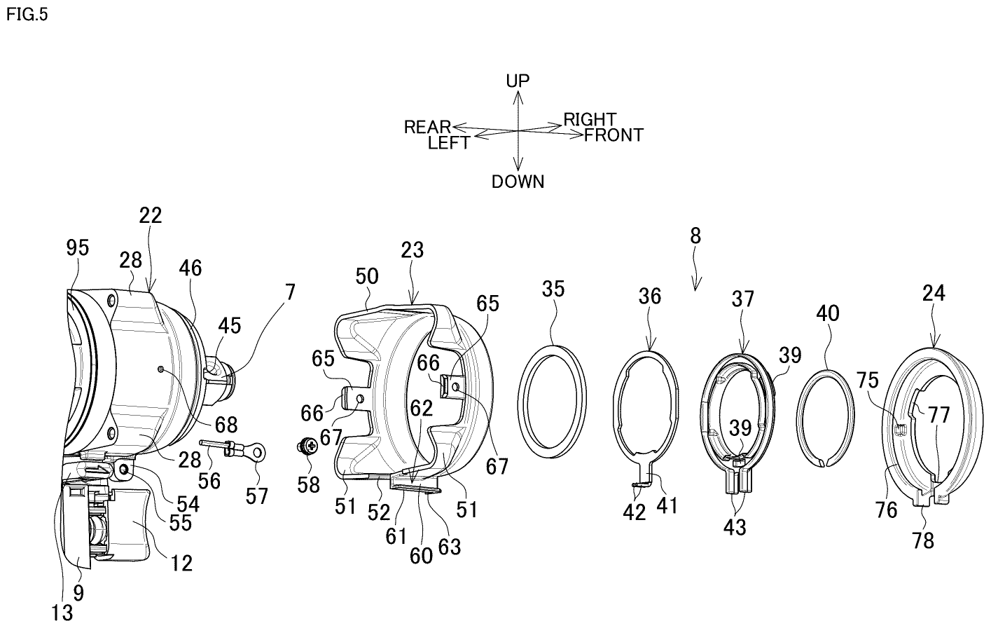

As illustrated also in FIG. 4, a flute 34 is formed on the front face of the hammer case 22 and outside in the radial direction of the front cylinder portion 31. The flute 34 has an open front face in a ring shape on a concentric circle with the axis lines of the anvil 7 and the front cylinder portion 31. The light unit 8 is disposed in the flute 34. As illustrated also in FIG. 5, the light unit 8 includes a sponge sheet 35, an LED board 36, and a board cover 37. The sponge sheet 35 has a ring shape and is arranged on the bottom surface of the flute 34. The LED board 36 is arranged on the front side of the sponge sheet 35. The LED board 36 has a ring shape and has a front face on which three LEDs 38 are arranged at equal intervals in a circumferential direction. The board cover 37 has a ring shape covering the LED board 36 from the front and has translucency. On the front face of the board cover 37, a plurality of lens units 39 are formed at equal intervals in the circumferential direction.

A stop ring 40 that retains the board cover 37 is locked on the outer circumference of the front cylinder portion 31. An extraction portion 41 is formed facing downward at the lower portion of the LED board 36. Light lead wires 42 are extracted from the extraction portion 41. The light lead wire 42 is an example of the lead wire for electrical component of the disclosure.

A pair of support pieces 43 to which the extraction portion 41 is fitted from the rear are formed facing downward at the lower portion of the board cover 37. The LED board 36 is housed in the board cover 37 from the rear in a phase where the extraction portion 41 is fitted between the support pieces 43. In this state, each lens unit 39 of the board cover 37 is positioned at the front of each LED 38 of the LED board 36. A fitting flute 44 is formed at the lower portion on the front face of the hammer case 22. The fitting flute 44 is communicated with the flute 34 and opens downward. In a housed state in the flute 34, the extraction portion 41 of the LED board 36 and the support pieces 43 of the board cover 37 are fitted to the fitting flute 44 and project below the hammer case 22.

A pair of cutouts 45 are formed at the right and left on the front face of the hammer case 22. A ring flute 46 is formed on the outer circumference of the hammer case 22 at the rear of the cutouts 45.

The hammer case cover 23 is made of resin and has a ring shape. The hammer case cover 23 covers the front portion, excluding the front end, of the hammer case 22 that projects from the tubular portion 26. One upper cover portion 50 and two lower cover portions 51 are disposed at the rear portion of the hammer case cover 23. The upper cover portion 50 covers the screw boss portions 28 at the upper right and left of the hammer case 22 from the front. The lower cover portions 51 independently cover the respective screw boss portions 28 at the lower right and left of the hammer case 22. A slit 52 extending forward from the rear end is formed between the lower cover portions 51. The hammer case cover 23 is an example of the cover of the disclosure.

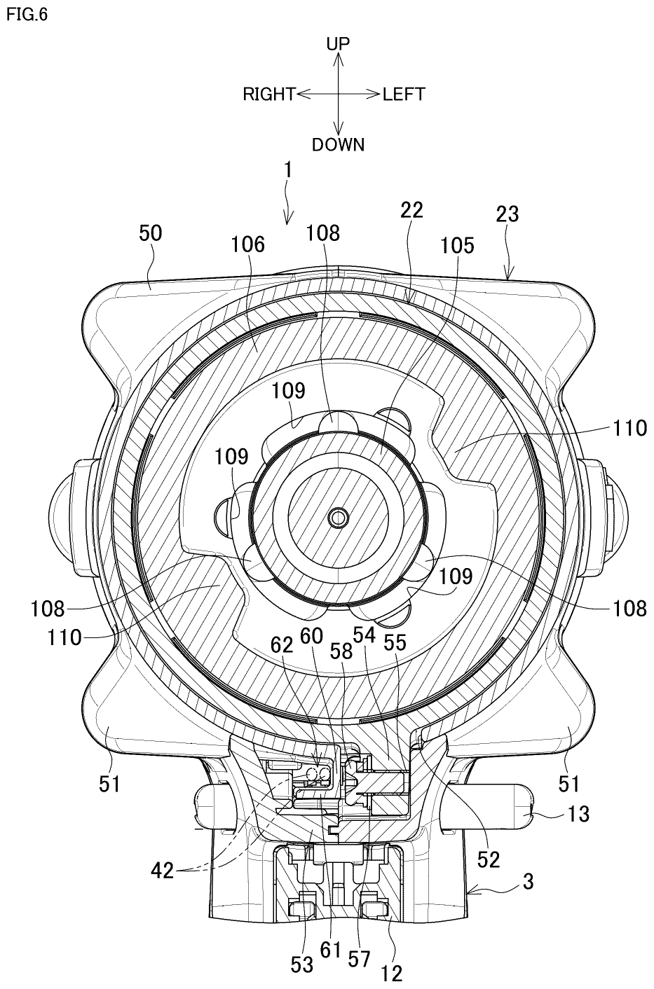

As illustrated also in FIG. 6, an extended portion 53 is formed at the lower portion of the tubular portion 26. The extended portion 53 projects forward and covers the lower surface of the hammer case cover 23. Respective halves of the extended portion 53 are formed on the right and left halved housings 20a, 20b and have front portions assembled with the screw 25. The extended portion 53 is an example of the outer housing covering the cover of the disclosure.

A grounding portion 54 is integrally formed at a position biased to the left on the lower surface of the hammer case 22. The grounding portion 54 is an example of the connecting portion and the screw fastening portion of the ground wire of the disclosure. The lower surface of the hammer case 22 is an example of the outer surface between the front and rear faces of the housing.

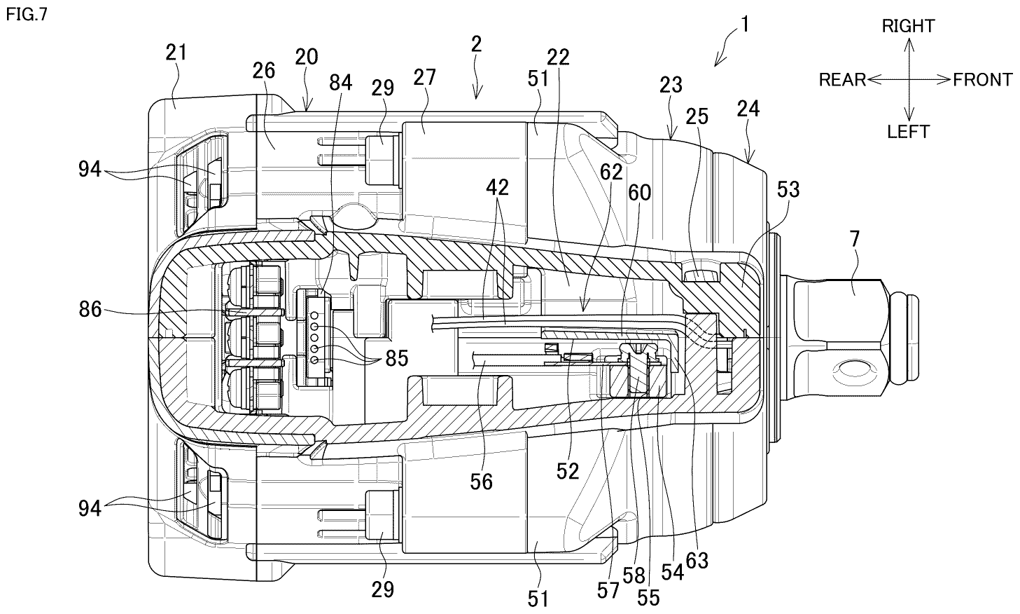

The grounding portion 54 has a plate shape defined in the up-down and front-rear directions and projects downward through the slit 52 into the extended portion 53. The grounding portion 54 is positioned rearward with respect to the screw 25 that secures the extended portion 53. A threaded hole 55 that penetrates in a left-right direction is formed in the grounding portion 54. As illustrated also in FIG. 7, the grounding portion 54 is disposed to electrically conduct the negative terminal of the terminal block 11 to the hammer case 22 through a grounding lead wire 56. The grounding lead wire 56 is installed in a conductive state by screwing a screw 58 passing through a terminal metal fitting 57 into the threaded hole 55 in a state where the terminal metal fitting 57 connected to the end portion of the grounding lead wire 56 is brought into contact with the right side of the grounding portion 54. As illustrated in FIG. 2, the grounding lead wire 56 passes between the hammer case cover 23 together with the hammer case 22 and the forward and reverse switching button 13 in the extended portion 53 and is extracted rearward. The grounding lead wire 56 is an example of the ground wire of the disclosure.

A partitioning portion 60 is formed on the lower surface of the hammer case cover 23. The partitioning portion 60 has a plate shape that projects downward from the right end of the slit 52 and extends in the front-rear direction. The partitioning portion 60 is positioned on the right side of the screw 58 with which the grounding lead wire 56 is installed and is close to the head of the screw 58 in a state where the hammer case cover 23 is assembled. A bent piece 61 that is bent to the right side is formed over the overall length at the lower end of the partitioning portion 60. Accordingly, the partitioning portion 60 and the bent piece 61 project from the lower surface of the hammer case cover 23 in an inverted L-shape in a front view. The bent piece 61 is an example of the bent portion disposed on the partitioning portion of the disclosure.

Thus, a linear wiring route 62 is formed on the lower side of the hammer case cover 23. The wiring route 62 is surrounded by the lower surface of the hammer case cover 23, the partitioning portion 60, and the bent piece 61 and opens on the right side. A front wall piece 63 that is bent to the left side is formed at the front end of the partitioning portion 60. The front wall piece 63 is positioned between the grounding portion 54 and the screw 25 with which the extended portion 53 is assembled.

As illustrated in FIG. 7, the light lead wires 42 extracted from the extraction portion 41 of the LED board 36 pass through the wiring route 62 on the right side of the partitioning portion 60 in the extended portion 53, pass between the hammer case cover 23 together with the hammer case 22 and the forward and reverse switching button 13, and are extracted rearward. Accordingly, the partitioning portion 60 made of resin is interposed between the light lead wires 42 and the terminal metal fitting 57 of the grounding lead wire 56 and the screw 58. Therefore, contact of the light lead wires 42 with the terminal metal fitting 57 and the screw 58 is avoided. In addition, the bent piece 61 at the lower end of the partitioning portion 60 restricts the movement of the light lead wires 42 to the lower side of the partitioning portion 60. As a result, the possibility that the light lead wires 42 go around the lower side of the partitioning portion 60 and come into contact with the terminal metal fitting 57 and the screw 58 is eliminated.

As illustrated in FIG. 3 to FIG. 5, installation pieces 65 are formed on the right and left of the hammer case cover 23. The installation pieces 65 extend rearward from the rear end of the hammer case cover 23 between the upper cover portion 50 and the lower cover portions 51. A locking piece 66, which is bent outward to the right or left, is formed at the rear end of each installation piece 65. A through hole 67 is formed to pass through each installation piece 65. Protrusions 68 are formed on the right and left side surfaces of the hammer case 22 in an assembly position of the hammer case cover 23. Each protrusion 68 is locked in the through hole 67 of the installation piece 65 to position the hammer case cover 23 with respect to the hammer case 22.

Fitting pieces 70 are formed at the right and left of the tubular portion 26. The fitting pieces 70 are fitted between the upper cover portion 50 and the lower cover portions 51 of the hammer case cover 23. A recessed portion 71 that covers the installation piece 65 of the hammer case cover 23 from the outside is formed on the inner surface of each fitting piece 70. A locking flute 72, to which the locking piece 66 of the installation piece 65 is locked, is formed at the rear end of each recessed portion 71. The locking piece 66 is locked in the locking flute 72 to bring the inner surface of the recessed portion 71 close to the outer surface of the installation piece 65, thereby retaining the installation piece 65 and avoiding detachment of the hammer case cover 23. At this time, the front end of the hammer case cover 23 is positioned outside in the radial direction at the rear end of the ring flute 46 of the hammer case 22.

The bumper 24 has a ring shape that covers the front end of the hammer case 22 at the front of the hammer case cover 23. The bumper 24 is made of resin and formed from an elastic material, such as elastomer. A pair of locking protrusions 75, which are locked in the cutouts 45 on the front face of the hammer case 22, are formed on the right and left of the rear face of the bumper 24. A hooking piece 76 that projects to the inner peripheral side over the whole circumference is formed at the rear end of the bumper 24. Positioning recessed portions 77, to which the lens units 39 of the board cover 37 are fitted, are formed on the inner circumference on the front face of the bumper 24. A cutout portion 78, to which the support pieces 43 of the board cover 37 are fitted, is formed at the lower portion on the rear face of the bumper 24.

The bumper 24 is positioned with respect to the board cover 37 by fitting each lens unit 39 of the board cover 37 to each positioning recessed portion 77 and fitting the support pieces 43 to the cutout portion 78. In this state, the locking protrusions 75 of the bumper 24 are aligned with the cutouts 45 of the hammer case 22, and the hooking piece 76 is locked in the ring flute 46. The bumper 24 is then assembled to the front end of the hammer case 22 on the front side of the hammer case cover 23. In this state, each lens unit 39 is exposed to the front face of the bumper 24 as illustrated in FIG. 1.

The motor 4 is an inner rotor type brushless motor including a stator 80 and a rotor 81 that passes through the stator 80. The stator 80 is held coaxially in the tubular portion 26. Six coils 83 that form a three-phase winding wire are wound around the stator 80 via front and rear insulators 82. As illustrated in FIG. 2, a sensor circuit board 84 is disposed on the front face of the front insulator 82. The sensor circuit board 84 includes a rotation detecting element (not illustrated) to detect the rotational position of the rotor 81. Signal lines 85 that output rotation detection signals are extracted downward from the lower portion of the sensor circuit board 84. A terminal unit 86, to which the three-phase winding wire is electrically connected, is disposed at the lower portion of the rear insulator 82. Three-phase power lines 87 are extracted downward from the terminal unit 86.

The rotor 81 has a rotation shaft 90 at its center. The rotation shaft 90 has a rear end supported by a bearing 91 that is held on the front inner surface of the rear cover 21. A fan 92 is disposed on the rotation shaft 90 between the stator 80 and the bearing 91. A plurality of inlet ports 93 are formed on the right and left side surfaces of the tubular portion 26. A plurality of exhaust ports 94 are formed on the right and left side surfaces of the rear cover 21.

A bearing box 95 is disposed in the tubular portion 26 at the front of the motor 4. The bearing box 95 has a disk-shaped rear view and is assembled to the rear end of the hammer case 22 to block the rear face of the hammer case 22. The front portion of the rotation shaft 90 passes through the bearing box 95 and is supported by a bearing 96 that is held on the rear face side of the bearing box 95.

The deceleration unit 5 includes a pinion 100, an internal gear 101, planetary gears 102, and a carrier portion 103. The pinion 100 is formed at the front end of the rotation shaft 90 that projects into the hammer case 22. The internal gear 101 is held in the rear portion of the hammer case 22, with its rotation restricted with respect to the bearing box 95. Three planetary gears 102 are arranged between the pinion 100 and the internal gear 101 and engage with both the pinion 100 and the internal gear 101. The carrier portion 103 supports the respective planetary gears 102 via three pins 104. The rear end of the carrier portion 103 is supported by a bearing 97 disposed on the front face side of the bearing box 95. A spindle 105 that extends forward at the center of the hammer case 22 is integrally formed with the carrier portion 103.

The hammering unit 6 includes a hammer 106, which is externally mounted on the spindle 105, and a coil spring 107, which biases the hammer 106 forward. As illustrated in FIG. 6, the hammer 106 is coupled in the direction of rotation by three balls 108 disposed between the hammer 106 and the spindle 105. Cam flutes 109, across which the balls 108 are fitted, are formed on the inner peripheral surface of the hammer 106 and the outer peripheral surface of the spindle 105. The coil spring 107 is externally mounted on the spindle 105 between the carrier portion 103 and the hammer 106 and biases the hammer 106 forward. The hammer 106 has a circular recessed portion on its front face, and houses the rear portion of the anvil 7 including the arm portions 30 in the recessed portion. As illustrated in FIG. 6, a pair of stops 110 are formed on the inner peripheral surface of the recessed portion. The stops 110 are engageable with the arm portions 30 of the anvil 7 in the direction of rotation. A closed-end hole 111 is formed in the shaft center of the anvil 7 from the rear end. A small-diameter portion 112 disposed at the front end of the spindle 105 is coaxially inserted into the closed-end hole 111.

A battery mounting portion 115 is disposed at the lower end of the handle 3. The battery pack 14 slides from the front to be mounted into the battery mounting portion 115.

The terminal block 11 is disposed in the battery mounting portion 115. The terminal block 11 includes three terminals 116 that are electrically connected to the mounted battery pack 14. Of these, two terminals 116 are for supplying positive and negative power sources, and one terminal 116 is for communicating temperature information and the like.

The controller 10 is housed in the battery mounting portion 115 on the upper side of the terminal block 11. The controller 10 includes a control circuit board 117. The control circuit board 117 includes a CPU and a memory connected to the CPU to control the rotation of the motor 4 and the operation of the light unit 8. A connector portion 118 and a switch panel 119 are disposed on the control circuit board 117. Lead wires that are wired to respective electrical parts are connected to the connector portion 118. The switch panel 119 is exposed to the front upper surface of the battery mounting portion 115 and allows switching operation of hammering force and modes and switching operation of active/inactive states of the light unit 8, which is whether or not it coordinates with ON/OFF of the switch 9.

The signal lines 85 extracted from the sensor circuit board 84 and the power lines 87 extracted from the terminal unit 86 pass behind the switch 9 in the handle 3 and are connected to the connector portion 118 on the control circuit board 117. A lead wire (not illustrated) extracted downward from the switch 9 is also connected to the connector portion 118.

After the light lead wires 42 pass between the hammer case 22 and the forward and reverse switching button 13 and are extracted rearward, they pass behind the switch 9 in the handle 3 and are connected to the connector portion 118.

The grounding lead wire 56 also passes between the hammer case 22 and the forward and reverse switching button 13 and is extracted rearward. Then, the grounding lead wire 56 passes behind the switch 9 in the handle 3, passes behind the controller 10, and is connected to the negative terminal 116 of the terminal block 11. Accordingly, once the battery pack 14 is mounted, the negative terminal of the battery pack 14 is electrically conducted with the hammer case 22 via the negative terminal 116 and the grounding lead wire 56.

In the impact wrench 1 configured as described above, the trigger 12 is pushed and operated with a hand gripping the handle 3. The switch 9 is then turned ON, and the control circuit board 117 supplies a three-phase current to the motor 4 from the power source of the battery pack 14. Accordingly, the rotation shaft 90 rotates together with the rotor 81, and the spindle 105 rotates at a reduced speed via the deceleration unit 5. When the spindle 105 rotates, the hammer 106 rotates via the balls 108. When the hammer 106 rotates, the anvil 7 rotates to allow tightening a bolt or the like with a socket.

The fan 92 rotates in association with the rotation of the rotation shaft 90. Then, external air drawn in from the inlet ports 93 is discharged from the exhaust ports 94, thereby internally generating an air flow and cooling the motor 4. When the light is active due to the operation of the switch panel 119, a current flows to the LED board 36 of the light unit 8 in association with the ON of the switch 9, and each LED 38 lights up. Accordingly, the light of the LED 38 is illuminated forward from each lens unit 39.

As the tightening progresses and the torque of the anvil 7 increases, the hammer 106, where a rotation difference has been generated relative to the spindle 105, retracts against the bias of the coil spring 107. Specifically, the hammer 106 rotates and retracts while rolling each ball 108 rearward along each cam flute 109. Then, when the stops 110 come free from the arm portions 30 of the anvil 7, the hammer 106 advances while rotating with the bias of the coil spring 107 and with the guide of each cam flute 109. Accordingly, the stops 110 re-engage with the arm portions 30, causing the anvil 7 to generate a rotational hammering force, namely an impact. The impact is repeated intermittently to perform further tightening.

Here, the negative terminal of the battery pack 14 is electrically conducted with the metallic hammer case 22 via the negative terminal 116 of the terminal block 11 and the grounding lead wire 56. In view of this, even when the impact wrench 1 is used in the vicinity of high-voltage power transmission lines, the controller 10 is not affected by electrical noise.

The grounding lead wire 56 is arranged on the lower side of the hammer case 22 and fastened with screws between the front and rear faces of the hammer case 22. Accordingly, even when the grounding lead wire 56 is provided, the overall length in the front-rear direction of the main body 2 does not increase. In addition, the grounding lead wire 56 is separated from the light lead wires 42 by the partitioning portion 60 of the hammer case cover 23. In view of this, even when vibration occurs during use, contact of the light lead wires 42 with the screw 58 with which the grounding lead wire 56 is installed is avoided, and contact of both lead wires 42, 56 with one another is avoided. Further, the partitioning portion 60 is close to the head of the screw 58. Therefore, even when the screw 58 is loosened due to vibration, detachment of the screw 58 is avoided, and the connection state of the grounding lead wire 56 is maintained.

The impact wrench 1 of the above-described embodiment includes the motor 4, the hammering unit 6 driven by the motor 4, the metallic hammer case 22, the hammer case cover 23 made of resin, the light unit 8 disposed at the front portion of the hammer case 22, and the battery mounting portion 115 to which the battery pack 14 as a power source is mountable. The hammer case 22 houses the hammering unit 6 and extends forward. The hammer case cover 23 covers the front portion of the hammer case 22. The battery mounting portion 115 has the positive and negative terminals 116 to which the mounted battery pack 14 is electrically connected.

Then, the grounding portion 54 is formed on the lower surface of the hammer case 22, and the partitioning portion 60 is formed in the hammer case cover 23. The grounding portion 54 is the connecting portion and screw fastening portion of the grounding lead wire 56 connected to the negative terminal 116 of the battery mounting portion 115. The partitioning portion 60 partitions between the light lead wires 42 connected to the light unit 8 and the grounding portion 54.

The configuration allows the grounding lead wire 56 to be fastened with screws between the front and rear faces of the hammer case 22, and it eliminates contact of the screw 58 with which the terminal metal fitting 57 is installed with the light lead wires 42 or contact of the grounding lead wire 56 with the light lead wires 42. Accordingly, even when the grounding lead wire 56 and the light lead wires 42 are provided, downsizing is not hindered, and the occurrence of defects associated with vibration, such as detachment of the screw 58 and wear of both lead wires 42, 56, can be effectively avoided.

The impact wrench 1 has the main body 2 and the handle 3. The main body 2 includes the motor 4 and the hammering unit 6 and extends in the front-rear direction. The handle 3 extends downward from the main body 2. The battery mounting portion 115 is disposed at the lower end of the handle 3. The grounding portion 54 is disposed on the lower surface of the hammer case 22. The partitioning portion 60 is disposed on the lower surface of the hammer case cover 23.

Accordingly, the grounding lead wire 56 can be fastened with screws to the hammer case 22 on the lower side of the main body 2, where the grounding lead wire 56 comes close to the negative terminal 116 of the battery mounting portion 115.

The partitioning portion 60 has the bent piece 61 that is bent to the light lead wires 42 side, and the hammer case cover 23, the partitioning portion 60, and the bent piece 61 form the wiring route 62 of the light lead wires 42.

Accordingly, the possibility that the light lead wires 42 go around the partitioning portion 60, move to the grounding lead wire 56 side, and come into contact with the screw 58 is eliminated.

The extended portion 53 that partially covers the hammer case cover 23 is disposed on the lower side of the hammer case cover 23, and the grounding portion 54 and the partitioning portion 60 are arranged between the hammer case cover 23 and the extended portion 53.

Accordingly, the extended portion 53 can be used to perform screw fastening of the grounding lead wire 56 and wiring of the light lead wires 42, and both lead wires 42, 56 are protected.

The partitioning portion 60 is integrally formed with the hammer case cover 23.

Accordingly, the partitioning portion 60 can be easily formed.

The partitioning portion 60 is positioned in a withdrawal direction of the screw 58 with which the grounding lead wire 56 is installed to the grounding portion 54 and is close to the head of the screw 58.

Accordingly, the partitioning portion 60 can effectively avoid detachment of the screw 58.

The electrical part is the light unit 8 for illumination.

Accordingly, wear and damage to the light lead wires 42 can be effectively avoided even when the light unit 8 is disposed at the front portion of the hammer case 22.

The output unit is the hammering unit 6 that applies intermittent hammering in the direction of rotation to the anvil 7 projecting forward. The housing is the hammer case 22 that supports the anvil 7. The cover is the hammer case cover 23 that covers the outside of the hammer case 22.

Accordingly, detachment of the screw 58 and wear of both lead wires 42, 56 can be effectively avoided in the impact wrench 1 that generates relatively large vibration during its use.

The grounding portion 54 is formed on the lower surface of the hammer case 22 and projects downward through the hammer case cover 23.

The partitioning portion 60 extends in the front-rear direction on the lower surface of the hammer case cover 23 and partitions between the grounding portion 54 and the light lead wire 42. In addition, the partitioning portion 60 is positioned in the withdrawal direction of the screw 58 with which the grounding lead wire 56 is installed to the grounding portion 54 and is close to the head of the screw 58.

The bent piece 61 that is bent to the light lead wires 42 side is formed at the lower end of the partitioning portion 60. The wiring route 62 of the light lead wires 42 is linearly formed by the hammer case cover 23, the partitioning portion 60, and the bent piece 61 in a state of overlapping with the grounding portion 54 and the grounding lead wire 56 in the left-right direction.

Accordingly, the grounding portion 54 and the grounding lead wire 56 can be arranged in a space-saving manner.

The following describes modification examples of the disclosure.

In the embodiment described above, the grounding portion as the screw fastening portion is disposed at a position biased to the left with respect to a position immediately below the hammer case. However, the screw fastening portion may be positioned immediately below the metallic housing or at a position biased to the right. The position of the screw fastening portion may be shifted to any of the front or rear from the position of the above-described embodiment. The screw fastening portion is not limited to the one that is integrally formed with the housing as in the above-described embodiment, but it may be formed by attaching a separate body to the housing.

The partitioning portion may be in contact with the head of the screw with which the ground wire is fastened. The partitioning portion may be longer or shorter in the front-rear direction than that of the above-described embodiment. The bent portion is not limited to the bent piece of the above-described embodiment, and the front and rear length of the bent portion can be changed, and the shape can be changed, as necessary. The front wall piece can also be changed to be longer in the left-right direction than that of the above-described embodiment. However, it is not necessary to have a bent portion or a front wall piece.

In the embodiment described above, the grounding portion is arranged on the left side, and the partitioning portion is arranged on the right side. However, the arrangement of both may be reversed left to right.

The partitioning portion is not limited to the one that is integrally formed with the cover, but it may be formed by attaching a separate body to the cover.

In the embodiment described above, the grounding portion and the partitioning portion are disposed on the lower surface of the hammer case. However, as long as they are between the front and rear faces of the housing, the grounding portion and the partitioning portion may be disposed on the side surface or the upper surface of the housing.

In the embodiment described above, the slit through which the grounding portion passes is provided in the hammer case cover. However, a through hole through which the grounding portion passes may be provided instead of the slit. In addition, the grounding portion may be disposed on the rear side with respect to the cover to avoid interference with the cover. In this case, it is only necessary to form the partitioning portion by extending it rearward from the rear end of the cover.

In the embodiment described above, the partitioning portion is disposed in the hammer case cover. However, the partitioning portion may be disposed in the bumper, or respective partitioning portions may be disposed in the hammer case cover and the bumper.

In the embodiment described above, the screw fastening portion is illustrated as an example as the connecting portion. However, the connecting portion is not limited to the screw fastening portion and may be another structure. The connecting portion may be a terminal insertion structure, such as a receptacle. In this case, downsizing is not hindered, and wear of wire can be effectively avoided.

The light at the front portion of the housing is not limited to that of the above-described embodiment. The number of LEDs can be increased or decreased, or the assembly structure of the LED board and the board cover can be changed. The light need not be ring-shaped like the light unit of the above-described embodiment.

The light is not limited to the one directly installed to the front portion of the housing. For example, the light may be disposed at the front portion of the extended portion. In this case, the partitioning portion can still be used to partition between the connecting portion and the light lead wire. The extended portion may be formed to be larger in the circumferential direction than that of the above-described embodiment.

The electrical part is not limited to the light for illumination. For example, the electrical part may be a lamp that displays an operating state, or it may be an operating unit, such as a button, switch, or dial.

The motor need not be brushless. The deceleration unit and the hammering unit are not limited to those of the above-described embodiment.

The impact tool may be an angle impact wrench in which a spindle is perpendicular to an anvil, or may be an impact driver. However, the disclosure is not limited to these impact tools but is also applicable to other electric power tools, such as a vibration driver drill. Accordingly, the metallic housing is not limited to the hammer case, and the cover is not limited to the hammer case cover. It is not necessary to have a bumper. The housing shape and the assembly structure that form the outer wall are not limited to those of the above-described embodiment.

In the embodiment described above, the connecting portion and the partitioning portion are provided as countermeasures against high voltage. However, the disclosure is also applicable to countermeasures against electromagnetic interference (EMI) and countermeasures against static electricity. When the disclosure applies to the countermeasures against EMI or countermeasures against static electricity, the ground wire is not necessarily connected only to the negative terminal of the battery mounting portion. For example, in the case of the countermeasures against EMI, the ground wire may be connected between an electromagnetic steel plate of the stator and a metal part, such as the hammer case.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. An electric power tool comprising:
a motor;
an output unit driven by the motor;
a metallic housing that houses the output unit and extends forward;
a cover made of resin that covers at least a part of the housing;
an electrical part disposed on a front portion side of the housing; and
a battery mounting portion to which a battery as a power source is mountable, the battery mounting portion having positive and negative terminals to which the mounted battery is electrically connected, wherein
on an outer surface between front and rear faces of the housing, a connecting portion of a ground wire connected to the negative terminal of the battery mounting portion is disposed in a conductive state with the outer surface, and
a partitioning portion is formed in the cover, the partitioning portion partitioning between a lead wire for electrical component connected to the electrical part and the connecting portion.

2. The electric power tool according to claim 1, further comprising:
a main body including the motor and the output unit and extending in a front-rear direction; and
a handle extending downward from the main body, wherein
the battery mounting portion is disposed at a lower end of the handle,
the connecting portion is disposed on a lower surface of the housing, and
the partitioning portion is disposed on a lower surface of the cover.

3. The electric power tool according to claim 2, wherein
the connecting portion projects downward from the lower surface of the housing through the cover,
the partitioning portion projects downward from the lower surface of the cover, and
the lead wire for electrical component is wired in a front-rear direction on an opposite side of the connecting portion across the partitioning portion.

4. The electric power tool according to claim 3, wherein
the connecting portion, the partitioning portion, and the lead wire for electrical component overlap with one another in a left-right direction.

5. The electric power tool according to claim 4, wherein
the connecting portion is integrally formed with the lower surface of the housing and projects downward through a slit formed on the lower surface of the cover, and
the partitioning portion is integrally formed with an end portion of the slit and projects downward.

6. The electric power tool according to claim 1, wherein
the partitioning portion has a bent portion that is bent to a side of the lead wire for electrical component, and
the cover, the partitioning portion, and the bent portion form a wiring route of the lead wire for electrical component.

7. The electric power tool according to claim 6, wherein
a front wall piece is disposed at a front end of the partitioning portion ahead of the connecting portion, and the front wall piece is bent to an opposite side of the bent portion.

8. The electric power tool according to claim 1, wherein
an outer housing that partially covers the cover is disposed on a lower side of the cover, and
the connecting portion and the partitioning portion are arranged between the cover and the outer housing.

9. The electric power tool according to claim 1, wherein
the partitioning portion is integrally formed with the cover.

10. The electric power tool according to claim 1, wherein
the connecting portion is a screw fastening portion, and
the partitioning portion is positioned in a withdrawal direction of a screw with which the ground wire is installed to the screw fastening portion and is close to or in contact with a head of the screw.

11. The electric power tool according to claim 10, wherein
the ground wire, the partitioning portion, and the lead wire for electrical component overlap with one another in a left-right direction.

12. The electric power tool according to claim 1, wherein
the electrical part is a light for illumination.

13. The electric power tool according to claim 1, wherein
the output unit is a hammering unit that applies intermittent hammering in a direction of rotation to an anvil projecting forward,
the housing is a hammer case that supports the anvil, and
the cover is a hammer case cover that covers an outside of the hammer case.

14. The electric power tool according to claim 1, wherein
the connecting portion is a screw fastening portion,
the screw fastening portion is formed on a lower surface of the housing and projects downward through the cover,
the partitioning portion extends in a front-rear direction on a lower surface of the cover and partitions between the screw fastening portion and the lead wire for electrical component, and the partitioning portion is positioned in a withdrawal direction of a screw with which the ground wire is installed to the screw fastening portion and is close to or in contact with a head of the screw, and
a bent portion that is bent to a side of the lead wire for electrical component is formed at a lower end of the partitioning portion, and a wiring route of the lead wire for electrical component is linearly formed by the cover, the partitioning portion, and the bent portion in a state of overlapping with the screw fastening portion and the ground wire in a left-right direction.
